(19) United States
(12) Patent Application Publication
(10) Pub. No.: US 2019/0055475 A1
(43) Pub. Date: Feb. 21, 2019

(54) METHOD FOR PROCESSING WEATHERED OIL SAND ORE

(71) Applicant: SYNCRUDE CANADA LTD. in trust for the owners of the Syncrude Project as such owners exist now and, Fort McMurray (CA)

(72) Inventors: JUN LONG, Edmonton (CA); SHANE HOSKINS, Edmonton (CA); YONG (JOE) GU, Edmonton (CA); YIN MING SAMSON NG, Sherwood Park (CA)

(21) Appl. No.: 15/678,946

(22) Filed: Aug. 16, 2017

(51) Int. Cl. C10G 1/04; B03B 1/02; B03B 1/04; B03B 9/02; B01D 17/00

(52) U.S. Cl. CPC C10G 1/047; B03B 1/02; B01D 17/10; B03B 9/02; B03B 1/04

(57) ABSTRACT

A process for extracting bitumen from weathered oil sand ore is provided, comprising mixing the weathered oil sand ore with heated water and sodium triphosphate to form a weathered oil sand slurry; adding sodium triphosphate to either the weathered oil sand ore, the heated water, or to the weathered oil sand slurry; conditioning the weathered oil sand slurry at a temperature of at least 50° C. to form a conditioned weathered oil sand slurry; and subjecting the conditioned weathered oil sand slurry to gravity separation at a temperature of at least 50° C. to form a bitumen froth product.

### FIELD OF THE INVENTION

The present invention relates generally to a method for processing weathered oil sand ore.

### BACKGROUND OF THE INVENTION

Oil sand ore, as known in the Athabasca region of Alberta, Canada, comprises water-wet, coarse sand grains having flecks of a viscous hydrocarbon, known as bitumen, trapped between the sand grains. The water sheaths surrounding the sand grains contain very fine clay particles. Thus, a sample of oil sand, for example, might comprise 70% by weight sand, 14% fines, 5% water and 11% bitumen. (All % values stated in this specification are to be understood to be % by weight.)

For many decades, the bitumen in Athabasca oil sand has been commercially recovered by the present applicant using a water-based process. In the first step of this process, the oil sand is slurried with process water, naturally entrained air and, optionally, caustic (NaOH). The slurry is mixed, for example in a tumbler or pipeline, for a prescribed retention time, to initiate a preliminary separation or dispersal of the bitumen and solids and to induce air bubbles to contact and aerate the bitumen. This step is referred to as “conditioning”.

The conditioned slurry is then further diluted with flood water and introduced into a large, open-topped, conical-bottomed, cylindrical vessel (termed a primary separation vessel or “PSV”). The diluted slurry is retained in the PSV under quiescent conditions for a prescribed retention period. During this period, aerated bitumen rises and forms a froth layer, which overflows the top lip of the vessel and is conveyed away in a launder. Sand grains sink and are concentrated in the conical bottom. They leave the bottom of the vessel as a wet tailings stream containing a small amount of bitumen. Middlings, a watery mixture containing solids and bitumen, extend between the froth and sand layers.

The wet tailings and middlings are separately withdrawn. The wet tailings can be either disposed or combined with the middlings for secondary bitumen recovery in a Tailings Oil Recovery (TOR) vessel. The midllings can also be sent alone to mechanical flotation cells or flotation columns for secondary bitumen recovery. The bitumen recovered from the secondary bitumen recovery process is recycled to the PSV. The froth produced by the PSV is subjected to further froth cleaning, i.e., removal of entrained water and solids, prior to upgrading.

Bitumen recovery is generally high when processing average to high grade oil sand ores. Typically, a “low grade” oil sand ore will contain between about 6 to 10 wt. % bitumen with about 25 to 35 wt. % fines. An “average grade” oil sand ore will typically contain at least 10 wt. % bitumen to about 11 wt. % bitumen with less than 30 wt. % fines and a “high grade” oil sand ore will typically contain greater than 11 wt. % bitumen with less than 25 wt. % fines. “Fines” are generally defined as those solids (e.g., silts, clays) having a size less about 44 μm.

It was discovered that when oil sand ore is exposed to the environment (air, moisture, etc.) for a lengthy period of time, significant changes in the physiochemical properties of the ore result. Such exposure is generally referred to as “weathering” or “aging”. Weathering generally occurs when mined oil sand ore is stockpiled for a few weeks or months or more prior to processing. Weathering may also occur on natural deposits of oil sands, such as those underneath a shallow layer of overburden.

Operational experience has shown that weathered ores are very difficult to process and could cause severe problems in extraction. For severely weathered ores, the bitumen could become unrecoverable. Weathered ores (or ores left in lump dumps or in stockpiles) often display some weathering characteristics.

There have only been a limited number of methods that have been proposed for weathered ore processing. However, most are not feasible for commercial operations. Chinese Patent CN 102585873 discloses a microbial enhanced oil recovery (MEOR) technology for the recovery of bitumen from weathered oil sands. MEOR uses microorganisms or their metabolic products to help the recovery of crude oil from reservoirs. It was found that microbial treatment was able to significantly improve the processability of weathered ores and the improvement was due to a collective contribution from the production of biosurfactants in the culture solution, the alteration of the solids wettability, the degradation of the asphaltenes, and the decrease in bitumen viscosity.

Canadian Patent No. 2,875,040 discloses a method for extracting bitumen from aged oil sands through the use of a non-aqueous solvent to form a solvent-dilute oil sand slurry and thus to obtain a bitumen-enriched stream by filtering the formed slurry. It was shown that the connate water of the aged oil sand has a sulfate content of at least 50 ppmv, as determined by ASTM D516.

U.S. Patent Application Publication No. 2003/0205507 discloses methods for identify ores containing degraded bitumen and teaches processing such ores by blending them with ores not containing degraded bitumen and using the hot water extraction process at high alkaline material addition (>0.05 wt %, preferably 0.1 wt %).

Wang, L.; Dang-Vu, T.; Xu, Z.; Masliyah, J., “Use of Short-Chain Amine in Processing of Weathered/Oxidized Oil Sands Ores”, Energy Fuels, 24, 3581-3588, 2010 tested short-chain amines for improving bitumen recovery from weathered/oxidized oil sands and n-Butylamine was found to be able to improve the extraction of bitumen from weathered/oxidized oil sands due to enhanced air-bitumen attachment.

Due to the need of stockpiling (especially in the case of frozen lumps during winter mining) and other reasons, weathered ores are often encountered and need to be processed in oil sands mining operations. However, the current water-based bitumen extraction processes are not able to process weathered ores. For severely aged ores, the current extraction processes could result in zero bitumen recovery. Thus, there is a need in the industry for a commercially feasible water-based extraction process for dealing with weathered ores.

### SUMMARY OF THE INVENTION

Broadly stated, in one aspect of the invention, a process is provided for extracting bitumen from weathered ores. As used herein, “weathered ore” means an ore that has been exposed to the environment (air, moisture, etc.) for a period long enough to result in significant changes in the physiochemical properties of the oil sand, with one or more of the following typical weathering characteristics:
reduced water content (≤2%),
increased contents of SO₄²⁻ (≥0.5%), Ca²⁺(≥0.1%), Mg²⁺ (0.06%) in connate water,
reduced sulfur content by up to 0.5% (absolute) and increased bitumen asphaltene content by up to 2% (absolute) in bitumen,
zero or very low bitumen recovery under normal extraction process conditions.

In one aspect of the present invention, sodium triphosphate (STP) (also called sodium tripolyphosphate (STPP) or tripolyphosphate (TPP)) is used as a process aid at high dosage in combination with a higher processing temperature for weathered ore processing. In particular, a process for extracting bitumen from weathered oil sand ore is provided, comprising:
mixing the weathered oil sand ore with heated water to form a weathered oil sand slurry;
adding sodium triphosphate to either the weathered oil sand ore, the heated water, or to the weathered oil sand slurry;
conditioning the weathered oil sand slurry at a temperature of at least 50° C., preferably 65° C., to form a conditioned weathered oil sand slurry; and
subjecting the conditioned weathered oil sand slurry to gravity separation at a temperature of at least 50° C., preferably 65° C., to form a bitumen froth product.

In one embodiment, the sodium triphosphate dosage is about 0.05 wt % or higher, preferably 0.1 wt % or higher, per tonne of dry oil sand.

In one embodiment, the temperature at the gravity separation step is maintained at 50° C., preferably 65° C., by adding heated water to the conditioned weathered oil sand slurry prior to subjecting it to gravity separation.

In one embodiment, the sodium triphosphate dosage range is between 0.05 and 0.2 wt % per tonne of dry oil sand. In one embodiment, the sodium triphosphate dosage is 0.16 wt % per tonne of dry oil sand. In one embodiment, when the dosage of sodium triphosphate is 0.16 wt %, the recovery of bitumen in the bitumen froth product is greater than 80%

### DESCRIPTION OF THE DRAWINGS

FIG. 1 is a schematic showing one embodiment of the method useful in the processing of weathered ore.

### DESCRIPTION OF THE PREFERRED EMBODIMENT

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

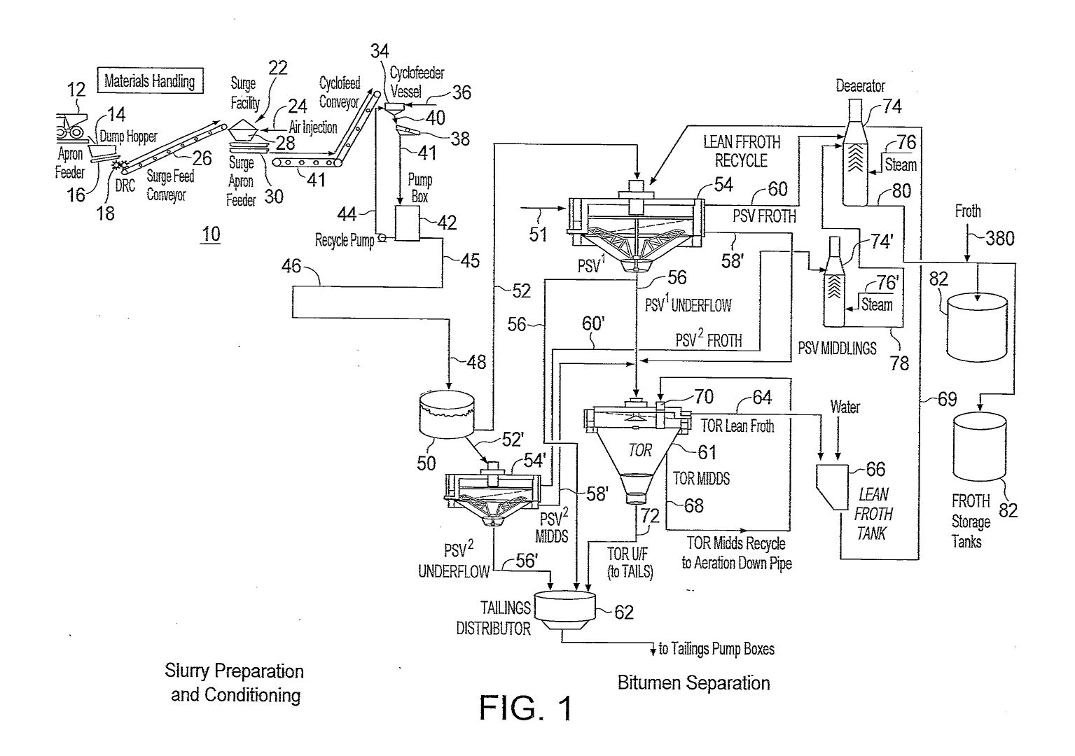

With reference to FIG. 1, weathered oil sand ore is mixed with heated slurry water and sodium triphosphate (STP) in a slurry preparation unit such as a rotating tumbler, cyclofeeder, mix box, wet crusher, etc., which is referred to herein as “slurry preparation”. It is understood, however, that STP can be either added to the slurry water, the weathered oil sand ore, or both, and/or to the weathered oil sand slurry. The minimum dosage of STP is generally greater than or equal to 0.05 wt % on a dry oil sand basis (per tonne) and preferably 0.1 wt % or higher on a dry oil sand basis.

The weathered oil sand slurry is then conditioned for a period of time in a tumbler or by transporting the slurry through a hydrotransport pipeline (referred to herein as “slurry conditioning”), where lump digestion, bitumen liberation, coalescence and aeration of liberated bitumen droplets occur. Slurry conditioning takes place at a temperature of about 50° C. or higher, preferably at around 65° C.

The conditioned weathered oil sand slurry is then diluted with flood water having a temperature of about 50° C. or higher, preferably at around 65° C., and subjected to gravity separation in a primary separation vessel (PSV), which step is referred to herein as “primary separation”. During primary separation, a bitumen froth (generally referred to as “primary froth”) floats to the top of the separation vessel, middlings comprising fine solids, water and poorly aerated bitumen, form below the froth layer, and coarse tails settle to the bottom of the separation vessel. The poorly aerated bitumen present in the middlings may be recovered in secondary separation vessels such as flotation cells and the like, which step is referred to herein as “secondary separation”. The lean bitumen froth recovered in the flotation cells may be recycled back to the PSV. The coarse tails produced in the PSV and the fine tails produced in the flotation cells may be further treated for disposal.

### Example 1

### Oil Sands

Three weathered oil sands (each exposed to the environment for ˜2.5 years) were collected for Batch Extraction Unit (BEU) testing. Both oil sands AX and AU were low-grade marine ore and oil sand AR was a high-grade estuarine ore.

Oil sand AX had a bitumen content of about 8.5% and a fines content of 21% (<44 μm). When oil sand AX was “fresh”, i.e., not weathered, this ore had a rejects-free bitumen recovery of ˜94% at a conditioning temperature of 45° C., a bitumen separation temperature of 35° C., and caustic addition of 0.01% on a dry oil sand basis. Such conditions are commercial conditions which will be referred to herein as “Heat Up Front Process” or “HUFP” conditions). However, weathered AX, under the same conditions, had a bitumen recovery of only 2.1%.

Oil Sand AU had a bitumen content of 9.5% and a fines content of 25% (<44 μm). When oil sand AU was “fresh”, i.e., not weathered, this ore had a bitumen recovery of ˜95% under HUFP conditions. However, weathered AU, under the same conditions, had a bitumen recovery of zero.

Oil sand AR was a high-grade low-fines good processing ore, having a bitumen content of 10.9% and a fines content of 20% (<44 μm). The bitumen recovery of this ore at fresh was 93% under HUFP conditions. However, weathered AR, under the same conditions, had a bitumen recovery of zero.

All three weathered oil sands were fully characterized to understand their physiochemical properties and the characterization results are summarized in Table 1 below.

TABLE 1
Summary of Oil Sand Characterization Results

| | Oil Sand | | | | | |
|---|---|---|---|---|---|---|
| | AX | | AU | | AR | |
| | Fresh | Aged | Fresh | Aged | Fresh | Aged |
| Aging time, days | 104 | 918 | 15 | 907 | 17 | 934 |
| Grade, wt % of Total Oil Sand | 8.8 | 8.5 | 10.3 | 9.5 | 11.3 | 10.9 |
| Fines Content, wt % (<44 μm) of | 12 | 10 | 12 | 23 | 23 | 24 |
| Total Solids | | | | | | |
| Water Content, wt % of Total Oil | 5.5 | 0.26 | 2.4 | 1.82 | 4.7 | 0.35 |
| Sand | | | | | | |
| Connate Water Ca²⁺ Content, | 0.1 | 3.0 | 0.05 | 0.3 | 0.03 | 1.4 |
| wt % of Total Connate Water | | | | | | |
| Connate Water SO₄²⁻ Content, | 0.56 | 11.6 | 0.46 | 1.3 | 0.26 | 3.0 |
| wt % of Total Connate Water | | | | | | |
| Bitumen Sulphur Content, wt % | 4.9 | 4.4 | 4.8 | 4.5 | 4.8 | 4.5 |
| of Total Biutmen | | | | | | |
| Bitumen Asphaltene Content, | 16.6 | 18.2 | 16.5 | 19.3 | 16.5 | 20.0 |
| wt % of Total Bitumen | | | | | | |

The weathering features of these severely weathered oil sands include (1) reduced water content (<2%), (2) increased divalent cation contents (Ca²⁺ and Mg²⁺), (3) increased sulfate content, and (4) decreased sulfur content but increased asphaltene content in bitumen.

### Ore Processability Tests

Batch scale oil sand processability tests using a batch extraction unit or “BEU” were performed (see Sanford, E., and Seyer, F., “Processability of Athabasca Tar Sand Using a Batch Extraction Unit: The Role of (Sodium Hydroxide) NaOH”, Can. Inst. Mining and Metall., Bull., 72(803) 164-169 (1979). In a batch scale processability test, a given amount of oil sand is added along with specified amounts of chemicals and process water to form a slurry in a pot. The formed slurry is conditioned at a specified conditioning temperature for a given time period. A certain amount of flood water is then added to the conditioned slurry. The temperature of the flood water can be the same or different from the conditioning temperature to control the temperature of the following bitumen separation process. To show the effect of processing temperature, both HUFP conditions (i.e., 45° C. for conditioning and 35° C. for bitumen separation) and Warm Slurry Extraction Process (WSEP) conditions (i.e., 50° C. for both conditioning and bitumen separation) were used. Table 2 provides a summary of the test temperatures.

TABLE 2
Ore Processability Test Conditions

| | |
|---|---|
| Process | Temperature, ° C. |

| Conditions | Conditioning | Bitumen Separation |
|---|---|---|
| WSEP | 50 | 50 |
| HUFP | 45 | 35 |

All three weathered oil sand ores were tested using either caustic as a process aid or STP. All chemical dosages are given as weight percent chemical per tonne of dry oil sand. The highest chemical dosages tested were 0.16 wt %. It should be noted, however, that the dosages of caustic tested herein are much higher than those used during commercial operations (i.e., generally less than 0.05 wt % used in commercial operations versus 0.16 wt % used in the BEU tests). The use of caustic at such high concentrations creates undesired consequences. Caustic is toxic and corrosive, impacting health and the environment and causing scaling on equipment due to precipitation of divalent cations when it is added to the slurry water for slurry preparation. Further, high amounts of caustic disperses fines, hindering fines settling and tailings treatment. Higher caustic dosages induce bitumen emulsification which impairs froth treatment and, hence, caustic at high dosages is not considered to be viable for use with weathered ores and is only used for comparison purposes.

The results of the batch scale ore processability tests are summarized in Table 3.

TABLE 3
Results of Bitumen Recovery in Percent

| | HUFP | | | | |
|---|---|---|---|---|---|
| | conditions | | HUFP | | |
| | and caustic | | conditions | WSEP conditions | |
| | at 0.01 wt % | | and STP at | with Caustic | WSEP with STP |
| Oil | Fresh | Aged | 0.16 wt % | at 0.16 wt % | at 0.16 wt % |
| Sand | Ore | Ore | Aged Ore | Aged Ore | Aged Ore |
| AX | 93.8 | 2.1 | 68 | 69.9 | 90.2 |
| AU | 95.3 | 0 | 30 | 37.8 | 84.5 |
| AR | 93.0 | 0 | 50 | 76.8 | 83.0 |

It can be seen from the results in Table 3 that increasing the conditioning and bitumen separation temperatures from 45 to 50° C. and 35 to 50° C., respectively, improved bitumen recovery at all instances. At lower temperatures (HUFF), the use of STP at a high dosage of 0.16 wt % did improve recovery but the improvement was limited. However, the combination of WSEP conditions plus the use of STP at a high dosage of 0.16 wt % improved bitumen recovery to above 83% and was consistent better than the combination of WSEP conditions and caustic at the same high dosage of 0.16 wt %. The recovery uplift by using STP instead of caustic (at the same concentration) was in the range of about 6 to about 47% (absolute) and averaged at ˜24%, compared to the use of caustic.

From the foregoing description, one skilled in the art can easily ascertain the essential characteristics of this invention, and without departing from the spirit and scope thereof, can make various changes and modifications of the invention to adapt it to various usages and conditions.

1. A process for extracting bitumen from weathered oil sand ore, comprising:
mixing the weathered oil sand ore with heated water to form a weathered oil sand slurry;
adding greater than 0.1 wt % per tonne dry oil sand ore of sodium triphosphate to either the weathered oil sand ore, the heated water, or to the weathered oil sand slurry;
conditioning the weathered oil sand slurry at a temperature of at least 50° C. to form a conditioned weathered oil sand slurry; and
subjecting the conditioned weathered oil sand slurry to gravity separation at a temperature of at least 50° C. to form a bitumen froth product.

2. The process as claimed in claim 1, wherein conditioning and gravity separation take place at between 50° C. to 80° C.

3. The process as claimed in claim 1, wherein the temperature of the gravity separation step is maintained at at least 50° C. by adding heated water to the conditioned weathered oil sand slurry prior to subjecting it to gravity separation.

4. (canceled)

5. (canceled)

6. The process as claimed in claim 1, wherein the amount of sodium triphosphate added is 0.16 wt % per tonne dry oil sand ore.

7. The process as claimed in claim 1, wherein the weathered oil sand ore comprises 2% water content or less.

8. The process as claimed in claim 1, wherein the weathered oil sand ore comprises connate water having greater than or equal to 0.5% SO₄²⁻, greater than or equal to 0.1% Ca²⁺ and/or about 0.06% Mg²⁺.

9. The process as claimed in claim 1, wherein the weathered oil sand ore comprises bitumen having a reduced sulfur content by up to 0.5% (absolute) and an increased bitumen asphaltene content.

10. The process as claimed in claim 1, wherein the weathered oil sand ore has very low bitumen recovery under normal extraction process conditions.

11. The process as claimed in claim 1, wherein the weathered oil sand ore: comprises 2% water content or less; comprises connate water having greater than or equal to 0.5% SO₄²⁻, greater than or equal to 0.1% Ca²⁺ and/or about 0.06% Mg²⁺; comprises bitumen having a reduced sulfur content by up to 0.5% (absolute) and an increased bitumen asphaltene content; and has very low bitumen recovery under normal extraction process conditions.

12. The process as claimed in claim 1, wherein conditioning and gravity separation take place at 65° C.

13. The process as claimed in claim 1, wherein the amount of sodium triphosphate added is greater than 0.1 wt % but less than or equal to 0.2 wt % per tonne dry oil sand ore.

14. The process as claimed in claim 1, wherein when the amount of sodium triphosphate added is 0.16 wt %, the recovery of bitumen in the bitumen froth product is greater than 80%.
